(19) United States
(12) Patent Application Publication
(10) Pub. No.: US 2010/0048290 A1
(43) Pub. Date: Feb. 25, 2010

(54) IMAGE COMBINING METHOD, SYSTEM AND APPARATUS

(75) Inventors: Nathan James Baseley, London (GB); Nicolas Doucet, London (GB)

Correspondence Address: KATTEN MUCHIN ROSENMAN LLP, 575 MADISON AVENUE, NEW YORK, NY, 10022-2585, US

(73) Assignee: Sony Computer Entertainment Europe Ltd., London (GB)

(21) Appl. No.: 12/193,868

(22) Filed: Aug. 19, 2008

(51) Int. Cl. A63F 9/24; A63F 13/00

(52) U.S. Cl. 463/25; 463/31

(57) ABSTRACT

A method of rewarding an end-user of a product. The method comprises supplying, in association with the product, an augmented reality marker for use with an augmented reality application. The augmented reality marker is provided as a free promotional supplement to the product.

### BACKGROUND OF THE INVENTION

1. Field of the Invention

The present invention relates to an image combining method, system and apparatus.

2. Description of the Prior Art

Recently, as processing units become ever more powerful, augmented reality features are increasingly being used in video game systems. For example, a video game called “The Eye of Judgement” published by Sony Computer Entertainment uses a system where game cards may be detected by a video camera and augmented reality images generated such that game features may be displayed superimposed on the detected game cards. Once a user has purchased the game, they may then further purchase additional packs of game cards which provide extra creatures and added game functionality. Such extension packs may also be provided with suitable software (for example stored on a CD-ROM), so that a video game system may detect the additional game cards. However, such additional packs assume that a user has already purchased the relevant game, and that they wish to own all of the game cards in the extension pack. Therefore, this method of supplying additional game cards may be somewhat limiting for a user if, for example, they only wish to use one particular game card, or if they are not sure whether purchasing the whole additional game pack will be worth the money. Additionally, distribution of the game cards and awareness of the game may be limited only to those users who are already interested in that game.

Other video game systems in which objects are distributed to end users so that the user can interact with a game are also known. For example, Barcode Battler (released by Epoch Co. Ltd. Japan in March 1991) is a handheld LCD games console which allows gamers to use different bar codes, scanned by a barcode reader of the game console, to battle against each other. In Barcode Battler, the bar codes are either provided with the game console, or a user may try and use a bar code printed on a retail product as a bar code for use with the game. Data encoded in the barcode is combined with a number generated by a random number generator so as to generate a game statistic. The game statistic is then compared with a game statistic of another user so as to determine the outcome of the battle.

However, as barcodes on retail products are not designed to specifically work with the console, whether a barcode on a product is of any value within the game can be somewhat unpredictable. Additionally, such systems offer little in the way of user interaction due to limited resolution of the screen and simplistic nature of the game play.

### SUMMARY OF THE INVENTION

An object of the present invention is to provide an improved method and apparatus for rewarding an end-user of a product.

A further object of the present invention is to provide an improved method and apparatus for interactive augmented reality game play.

In a first aspect, there is provided a method of rewarding an end-user of a product. The method comprises supplying, in association with the product, an augmented reality marker for use with an augmented reality application. The augmented reality marker is provided as a free promotional supplement to the product.

In a second aspect, there is provided an image combining method for combining virtual images with real images captured by a video camera so as to generate augmented reality images at a client device associated with an end-user. The client device has an image receiver and a data receiver. The method includes storing, at a data source, augmented reality marker data, and supplying, in association with a product, an augmented reality marker to the user. The augmented reality marker is provided as a free promotional supplement to the product, and the augmented reality marker is associated with the augmented reality marker data. The method further includes capturing a sequence of video images of the augmented reality marker, receiving, using the image receiver, the sequence of video images via an image communication link, and receiving, using the data receiver, the augmented reality marker data from the data source. The method also includes detecting, at the client device, an image feature corresponding to the augmented reality marker within the sequence of video images. The augmented reality marker is detected in dependence upon the augmented reality marker data received from the data source. The method additionally includes generating, at the client device, a virtual reality image in dependence upon the augmented reality marker data received from the data source, and combining, at the client device, the virtual reality image with the sequence of video images at an image position substantially corresponding to the image feature so as to generate augmented reality images.

In a third aspect, there is provided an image combining system arranged to combine virtual images with real images captured by a video camera so as to generate augmented reality images. The system comprises a data source arranged to store augmented reality marker data, and a supply source arranged to supply, in association with a product, an augmented reality marker to an end-user. The augmented reality marker is provided as a free promotional supplement to the product, and the augmented reality marker is associated with the augmented reality marker data. The system includes a video camera operable to capture video images of the augmented reality marker, and a client device associated with the end-user. The client device includes an image receiver operable to receive a sequence of video images from the video camera via an image communication link, and a data receiver operable to receive the augmented reality marker data from the data source. The client device further includes a detector operable to detect, within the sequence of video images, an image feature corresponding to the augmented reality marker which was supplied from the supply source. The image feature is detected in dependence upon the augmented reality marker data received from the data source. The client device also includes a processor operable to generate a virtual reality image in dependence upon the augmented reality marker data received from the data source, and combine the virtual reality image with the sequence of video images at an image position substantially corresponding to the image feature so as to generate augmented reality images.

In a fourth aspect, there is provided an image combining device for combining virtual images with real images captured by a video camera so as to generate augmented reality images. The device is associated with an end-user. The device includes an image receiver operable to receive a sequence of video images from the video camera via an image communication link and a data receiver operable to receive augmented reality marker data from a data source. The augmented reality marker data is associated with an augmented reality marker. The device further includes a detector operable to detect, within the sequence of video images, an image feature corresponding to the augmented reality marker. The augmented reality marker is supplied to the end-user in association with a product, and the augmented reality marker is provided as a free promotional supplement to the product. The image feature is detected in dependence upon the augmented reality marker data received from the data source. The device also includes a processor operable to generate a virtual reality image in dependence upon the augmented reality marker data received from the data source, and combine the virtual reality image with the sequence of video images at an image position substantially corresponding to the image feature so as to generate augmented reality images.

In a fifth aspect there is provided an augmented reality marker for use with an augmented reality generation system. The augmented reality marker comprises a primary facet comprising an image for recognition by said augmented reality generation system, and one or more secondary facets arranged with respect to said primary facet such that said primary facet is not parallel to said one or more secondary facets.

By providing an augmented reality marker in association with a product, in which the augmented reality marker is provided as a free promotional supplement to the product, embodiments of the present invention advantageously encourage and reward an end-user of the product to purchase that product and/or a product or event associated with the augmented reality marker. For example, the augmented reality marker may be provided by a film or television company in association with an augmented reality application such as a video game so as to allow a user to interact with the video game using the augmented reality marker. Furthermore, greater functionality and interaction between an end-user and an entertainment device may be achieved because of the rich augmented reality experience that it is possible to create using augmented reality markers.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 is a schematic diagram of an entertainment device;

FIG. 2 is a schematic diagram of a cell processor;

FIG. 3 is a schematic diagram of a video graphics processor;

FIG. 4 is a schematic diagram of an arrangement of an entertainment system with respect to an augmented reality marker in accordance with an embodiment of the present invention;

FIG. 5 is a schematic diagram of an example of an augmented reality marker in accordance with an embodiment of the present invention;

FIG. 6 is a schematic diagram of an alternative view of the augmented reality marker of FIG. 5;

FIG. 7 is a schematic diagram of a representation of polyhedral net which may be used to form an augmented reality marker in accordance with an embodiment of the present invention;

FIG. 8 is a schematic diagram of a product together with an augmented reality marker for supply to an end user in accordance with an embodiment of the present invention;

FIG. 9 is a schematic diagram of a system for supplying a product and an augmented reality marker to a plurality of end users in accordance with an embodiment of the present invention;

FIG. 10 is a flowchart of a method of combining virtual images with real images so as to generate augmented reality images in accordance with an embodiment of the present invention; and

FIG. 11A is a schematic diagram of an augmented reality marker in accordance with an embodiment of the present invention, and FIG. 11B is a cross-sectional view of the augmented reality marker shown in FIG. 11A.

### DESCRIPTION OF THE PREFERRED EMBODIMENTS

An image combining method, system and apparatus is disclosed. In the following description, a number of specific details are presented in order to provide a thorough understanding of embodiments of the present invention. It will be apparent however to a person skilled in the art that these specific details need not be employed to practise the present invention. Conversely, specific details known to the person skilled in the art are omitted for the purposes of clarity in presenting the embodiments.

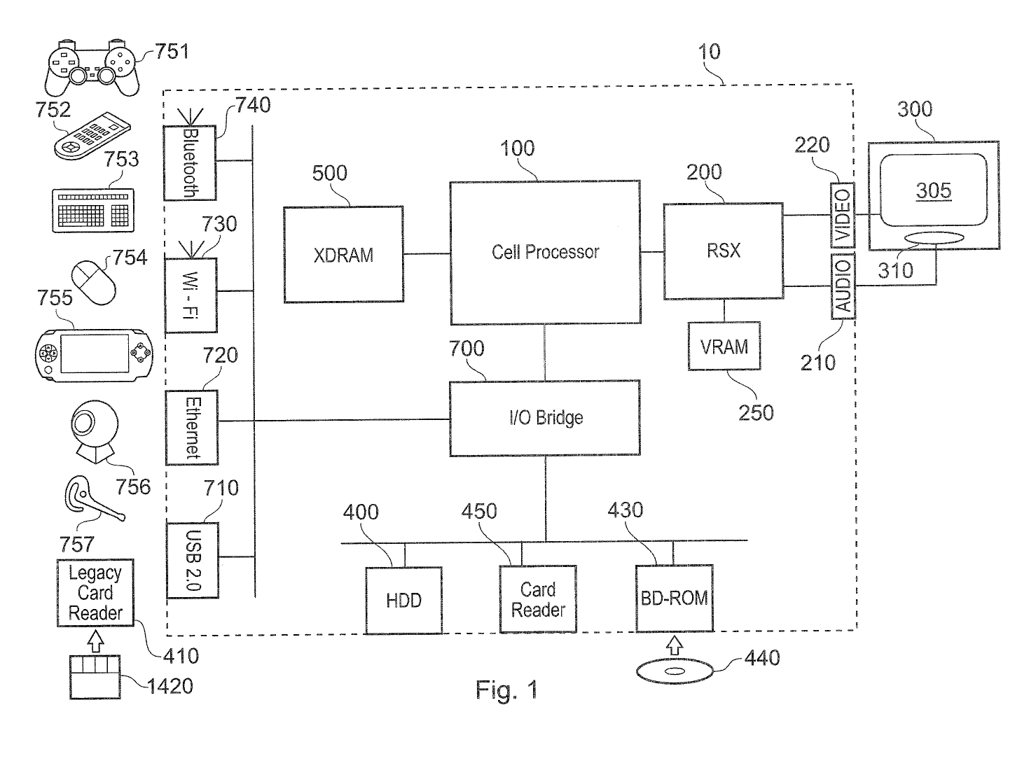

FIG. 1 schematically illustrates the overall system architecture of the Sony® Playstation 3® entertainment device. A system unit 10 is provided, with various peripheral devices connectable to the system unit.

The system unit 10 comprises: a Cell processor 100; a Rambus® dynamic random access memory (XDRAM) unit 500; a Reality Synthesiser graphics unit 200 with a dedicated video random access memory (VRAM) unit 250; and an I/O bridge 700.

The system unit 10 also comprises a Blu Ray® Disk BD-ROM® optical disk reader 430 for reading from a disk 440 and a removable slot-in hard disk drive (HDD) 400, accessible through the I/O bridge 700. Optionally the system unit also comprises a memory card reader 450 for reading compact flash memory cards, Memory Stick® memory cards and the like, which is similarly accessible through the I/O bridge 700.

The I/O bridge 700 also connects to four Universal Serial Bus (USB) 2.0 ports 710; a gigabit Ethernet port 720; an IEEE 802.11b/g wireless network (Wi-Fi) port 730; and a Bluetooth® wireless link port 740 capable of supporting up to seven Bluetooth connections.

In operation the I/O bridge 700 handles all wireless, USB and Ethernet data, including data from one or more game controllers 751. For example when a user is playing a game, the I/O bridge 700 receives data from the game controller 751 via a Bluetooth link and directs it to the Cell processor 100, which updates the current state of the game accordingly.

The wireless, USB and Ethernet ports also provide connectivity for other peripheral devices in addition to game controllers 751, such as: a remote control 752; a keyboard 753; a mouse 754; a portable entertainment device 755 such as a Sony Playstation Portable®) entertainment device; a video camera such as an EyeToy® video camera 756; and a microphone headset 757. Such peripheral devices may therefore in principle be connected to the system unit 10 wirelessly; for example the portable entertainment device 755 may communicate via a Wi-Fi ad-hoc connection, whilst the microphone headset 757 may communicate via a Bluetooth link.

The provision of these interfaces means that the Playstation 3 device is also potentially compatible with other peripheral devices such as digital video recorders (DVRs), set-top boxes, digital cameras, portable media players, Voice over IP telephones, mobile telephones, printers and scanners.

In addition, a legacy memory card reader 410 may be connected to the system unit via a USB port 710, enabling the reading of memory cards 420 of the kind used by the Playstation® or Playstation 2® devices.

In the present embodiment, the game controller 751 is operable to communicate wirelessly with the system unit 10 via the Bluetooth link. However, the game controller 751 can instead be connected to a USB port, thereby also providing power by which to charge the battery of the game controller 751. In addition to one or more analogue joysticks and conventional control buttons, the game controller is sensitive to motion in 6 degrees of freedom, corresponding to translation and rotation in each axis. Consequently gestures and movements by the user of the game controller may be translated as inputs to a game in addition to or instead of conventional button or joystick commands. Optionally, other wirelessly enabled peripheral devices such as the Playstation Portable device may be used as a controller. In the case of the Playstation Portable device, additional game or control information (for example, control instructions or number of lives) may be provided on the screen of the device. Other alternative or supplementary control devices may also be used, such as a dance mat (not shown), a light gun (not shown), a steering wheel and pedals (not shown) or bespoke controllers, such as a single or several large buttons for a rapid-response quiz game (also not shown).

The remote control 752 is also operable to communicate wirelessly with the system unit 10 via a Bluetooth link. The remote control 752 comprises controls suitable for the operation of the Blu Ray Disk BD-ROM reader 430 and for the navigation of disk content.

The Blu Ray Disk BD-ROM reader 430 is operable to read CD-ROMs compatible with the Playstation and PlayStation 2 devices, in addition to conventional pre-recorded and recordable CDs, and so-called Super Audio CDs. The reader 430 is also operable to read DVD-ROMs compatible with the Playstation 2 and PlayStation 3 devices, in addition to conventional pre-recorded and recordable DVDs. The reader 430 is further operable to read BD-ROMs compatible with the Playstation 3 device, as well as conventional pre-recorded and recordable Blu-Ray Disks.

The system unit 10 is operable to supply audio and video, either generated or decoded by the Playstation 3 device via the Reality Synthesiser graphics unit 200, through audio and video connectors to a display and sound output device 300 such as a monitor or television set having a display 305 and one or more loudspeakers 310. The audio connectors 210 may include conventional analogue and digital outputs whilst the video connectors 220 may variously include component video, S-video, composite video and one or more High Definition Multimedia Interface (HDMI) outputs. Consequently, video output may be in formats such as PAL or NTSC, or in 720 p, 1080 i or 1080 p high definition.

Audio processing (generation, decoding and so on) is performed by the Cell processor 100. The Playstation 3 device's operating system supports Dolby® 5.1 surround sound, Dolby® Theatre Surround (DTS), and the decoding of 7.1 surround sound from Blu-Ray® disks.

In the present embodiment, the video camera 756 comprises a single charge coupled device (CCD), an LED indicator, and hardware-based real-time data compression and encoding apparatus so that compressed video data may be transmitted in an appropriate format such as an intra-image based MPEG (motion picture expert group) standard for decoding by the system unit 10. The camera LED indicator is arranged to illuminate in response to appropriate control data from the system unit 10, for example to signify adverse lighting conditions. Embodiments of the video camera 756 may variously connect to the system unit 10 via a USB, Bluetooth or Wi-Fi communication port. Embodiments of the video camera may include one or more associated microphones and also be capable of transmitting audio data. In embodiments of the video camera, the CCD may have a resolution suitable for high-definition video capture. In use, images captured by the video camera may for example be incorporated within a game or interpreted as game control inputs.

In general, in order for successful data communication to occur with a peripheral device such as a video camera or remote control via one of the communication ports of the system unit 10, an appropriate piece of software such as a device driver should be provided. Device driver technology is well-known and will not be described in detail here, except to say that the skilled man will be aware that a device driver or similar software interface may be required in the present embodiment described.

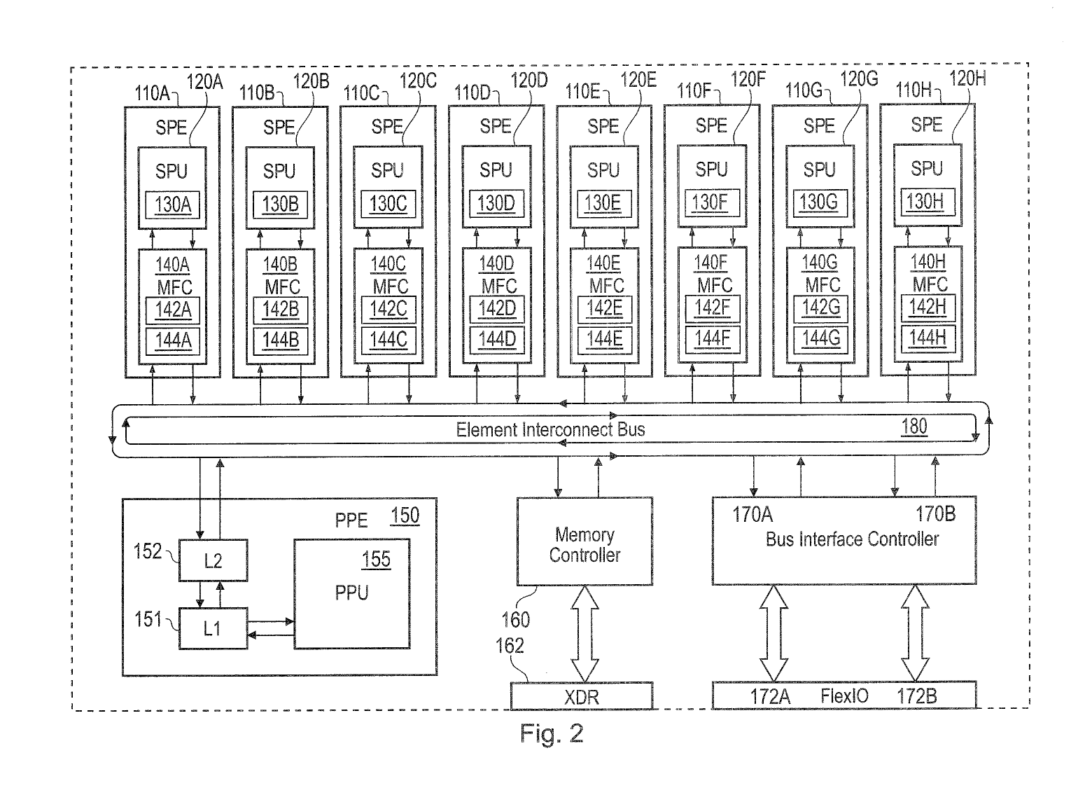

Referring now to FIG. 2, the Cell processor 100 has an architecture comprising four basic components: external input and output structures comprising a memory controller 160 and a dual bus interface controller 170A,B; a main processor referred to as the Power Processing Element 150; eight co-processors referred to as Synergistic Processing Elements (SPEs) 110A-H; and a circular data bus connecting the above components referred to as the Element Interconnect Bus 180. The total floating point performance of the Cell processor is 218 GFLOPS, compared with the 6.2 GFLOPs of the Playstation 2 device's Emotion Engine.

The Power Processing Element (PPE) 150 is based upon a two-way simultaneous multithreading Power 970 compliant PowerPC core (PPU) 155 running with an internal clock of 3.2 GHz. It comprises a 512 kB level 2 (L2) cache and a 32 kB level 1 (L1) cache. The PPE 150 is capable of eight single position operations per clock cycle, translating to 25.6 GFLOPs at 3.2 GHz. The primary role of the PPE 150 is to act as a controller for the Synergistic Processing Elements 110A-H, which handle most of the computational workload. In operation the PPE 150 maintains a job queue, scheduling jobs for the Synergistic Processing Elements 110A-H and monitoring their progress. Consequently each Synergistic Processing Element 110A-H runs a kernel whose role is to fetch a job, execute it and synchronise with the PPE 150.

Each Synergistic Processing Element (SPE) 110A-H comprises a respective Synergistic Processing Unit (SPU) 120A-H, and a respective Memory Flow Controller (MFC) 140A-H comprising in turn a respective Dynamic Memory Access Controller (DMAC) 142A-H, a respective Memory Management Unit (MMU) 144A-H and a bus interface (not shown). Each SPU 120A-H is a RISC processor clocked at 3.2 GHz and comprising 256 kB local RAM 130A-H, expandable in principle to 4 GB. Each SPE gives a theoretical 25.6 GFLOPS of single precision performance. An SPU can operate on 4 single precision floating point members, 4 32-bit numbers, 8 16-bit integers, or 16 8-bit integers in a single clock cycle. In the same clock cycle it can also perform a memory operation. The SPU 120A-H does not directly access the system memory XDRAM 500; the 64-bit addresses formed by the SPU 120A-H are passed to the MFC 140A-H which instructs its DMA controller 142A-H to access memory via the Element Interconnect Bus 180 and the memory controller 160.

The Element Interconnect Bus (EIB) 180 is a logically circular communication bus internal to the Cell processor 100 which connects the above processor elements, namely the PPE 150, the memory controller 160, the dual bus interface 170A,B and the 8 SPEs 110A-H, totalling 12 participants. Participants can simultaneously read and write to the bus at a rate of 8 bytes per clock cycle. As noted previously, each SPE 110A-H comprises a DMAC 142A-H for scheduling longer read or write sequences. The EIB comprises four channels, two each in clockwise and anti-clockwise directions. Consequently for twelve participants, the longest step-wise data-flow between any two participants is six steps in the appropriate direction. The theoretical peak instantaneous EIB bandwidth for 12 slots is therefore 96B per clock, in the event of full utilisation through arbitration between participants. This equates to a theoretical peak bandwidth of 307.2 GB/s (gigabytes per second) at a clock rate of 3.2 GHz.

The memory controller 160 comprises an XDRAM interface 162, developed by Rambus Incorporated. The memory controller interfaces with the Rambus XDRAM 500 with a theoretical peak bandwidth of 25.6 GB/s.

The dual bus interface 170A,B comprises a Rambus FlexIO® system interface 172A,B. The interface is organised into 12 channels each being 8 bits wide, with five paths being inbound and seven outbound. This provides a theoretical peak bandwidth of 62.4 GB/s (36.4 GB/s outbound, 26 GB/s inbound) between the Cell processor and the I/O Bridge 700 via controller 170A and the Reality Simulator graphics unit 200 via controller 170B.

Data sent by the Cell processor 100 to the Reality Simulator graphics unit 200 will typically comprise display lists, being a sequence of commands to draw vertices, apply textures to polygons, specify lighting conditions, and so on.

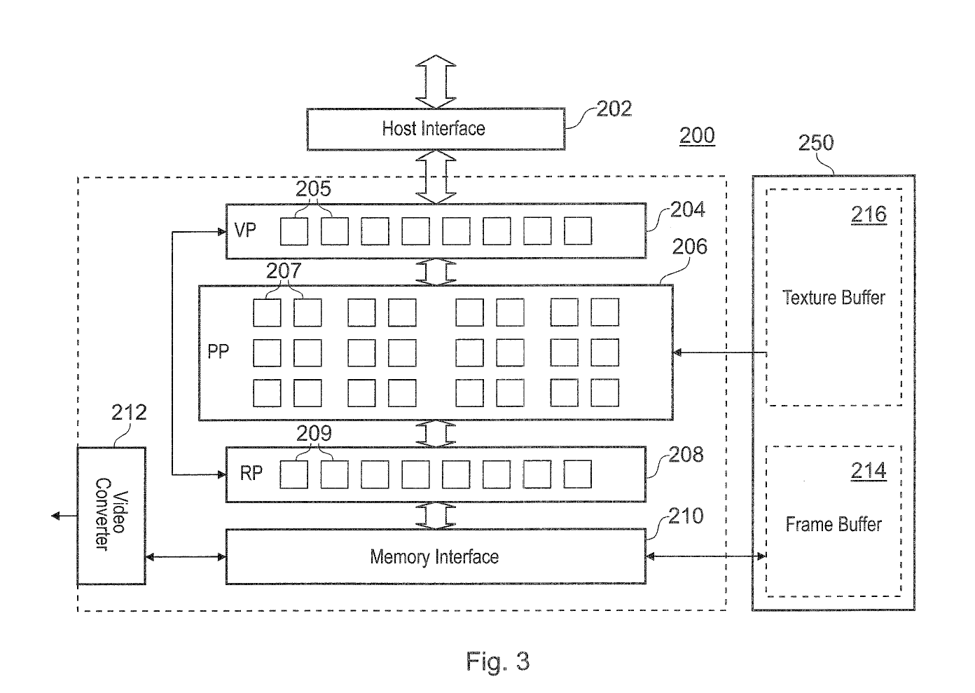

Referring now to FIG. 3, the Reality Simulator graphics (RSX) unit 200 is a video accelerator based upon the NVidia® G70/71 architecture that processes and renders lists of commands produced by the Cell processor 100. The RSX unit 200 comprises a host interface 202 operable to communicate with the bus interface controller 170B of the Cell processor 100; a vertex pipeline 204 (VP) comprising eight vertex shaders 205; a pixel pipeline 206 (PP) comprising 24 pixel shaders 207; a render pipeline 208 (RP) comprising eight render output units (ROPs) 209; a memory interface 210; and a video converter 212 for generating a video output. The RSX 200 is complemented by 256 MB double data rate (DDR) video RAM (VRAM) 250, clocked at 600 MHz and operable to interface with the RSX 200 at a theoretical peak bandwidth of 25.6 GB/s. In operation, the VRAM 250 maintains a frame buffer 214 and a texture buffer 216. The texture buffer 216 provides textures to the pixel shaders 207, whilst the frame buffer 214 stores results of the processing pipelines. The RSX can also access the main memory 500 via the EIB 180, for example to load textures into the VRAM 250.

The vertex pipeline 204 primarily processes deformations and transformations of vertices defining polygons within the image to be rendered.

The pixel pipeline 206 primarily processes the application of colour, textures and lighting to these polygons, including any pixel transparency, generating red, green, blue and alpha (transparency) values for each processed pixel. Texture mapping may simply apply a graphic image to a surface, or may include bump-mapping (in which the notional direction of a surface is perturbed in accordance with texture values to create highlights and shade in the lighting model) or displacement mapping (in which the applied texture additionally perturbs vertex positions to generate a deformed surface consistent with the texture).

The render pipeline 208 performs depth comparisons between pixels to determine which should be rendered in the final image. Optionally, if the intervening pixel process will not affect depth values (for example in the absence of transparency or displacement mapping) then the render pipeline and vertex pipeline 204 can communicate depth information between them, thereby enabling the removal of occluded elements prior to pixel processing, and so improving overall rendering efficiency. In addition, the render pipeline 208 also applies subsequent effects such as full-screen anti-aliasing over the resulting image.

Both the vertex shaders 205 and pixel shaders 207 are based on the shader model 3.0 standard. Up to 136 shader operations can be performed per clock cycle, with the combined pipeline therefore capable of 74.8 billion shader operations per second, outputting up to 840 million vertices and 10 billion pixels per second. The total floating point performance of the RSX 200 is 1.8 TFLOPS.

Typically, the RSX 200 operates in close collaboration with the Cell processor 100; for example, when displaying an explosion, or weather effects such as rain or snow, a large number of particles must be tracked, updated and rendered within the scene. In this case, the PPU 155 of the Cell processor may schedule one or more SPEs 110A-H to compute the trajectories of respective batches of particles. Meanwhile, the RSX 200 accesses any texture data (e.g. snowflakes) not currently held in the video RAM 250 from the main system memory 500 via the element interconnect bus 180, the memory controller 160 and a bus interface controller 170B. The or each SPE 110A-H outputs its computed particle properties (typically coordinates and normals, indicating position and attitude) directly to the video RAM 250; the DMA controller 142A-H of the or each SPE 110A-H addresses the video RAM 250 via the bus interface controller 170B. Thus in effect the assigned SPEs become part of the video processing pipeline for the duration of the task.

In general, the PPU 155 can assign tasks in this fashion to six of the eight SPEs available; one SPE is reserved for the operating system, whilst one SPE is effectively disabled. The disabling of one SPE provides a greater level of tolerance during fabrication of the Cell processor, as it allows for one SPE to fail the fabrication process. Alternatively if all eight SPEs are functional, then the eighth SPE provides scope for redundancy in the event of subsequent failure by one of the other SPEs during the life of the Cell processor.

The PPU 155 can assign tasks to SPEs in several ways. For example, SPEs may be chained together to handle each step in a complex operation, such as accessing a DVD, video and audio decoding, and error masking, with each step being assigned to a separate SPE. Alternatively or in addition, two or more SPEs may be assigned to operate on input data in parallel, as in the particle animation example above.

Software instructions implemented by the Cell processor 100 and/or the RSX 200 may be supplied at manufacture and stored on the HDD 400, and/or may be supplied on a data carrier or storage medium such as an optical disk or solid state memory, or via a transmission medium such as a wired or wireless network or internet connection, or via combinations of these.

The software supplied at manufacture comprises system firmware and the Playstation 3 device's operating system (OS). In operation, the OS provides a user interface enabling a user to select from a variety of functions, including playing a game, listening to music, viewing photographs, or viewing a video. The interface takes the form of a so-called cross media-bar (XMB), with categories of function arranged horizontally. The user navigates by moving through the function icons (representing the functions) horizontally using the game controller 751, remote control 752 or other suitable control device so as to highlight a desired function icon, at which point options pertaining to that function appear as a vertically scrollable list of option icons centred on that function icon, which may be navigated in analogous fashion. However, if a game, audio or movie disk 440 is inserted into the BD-ROM optical disk reader 430, the Playstation 3 device may select appropriate options automatically (for example, by commencing the game), or may provide relevant options (for example, to select between playing an audio disk or compressing its content to the HDD 400).

In addition, the OS provides an on-line capability, including a web browser, an interface with an on-line store from which additional game content, demonstration games (demos) and other media may be downloaded, and a friends management capability, providing on-line communication with other Playstation 3 device users nominated by the user of the current device; for example, by text, audio or video depending on the peripheral devices available. The on-line capability also provides for on-line communication, content download and content purchase during play of a suitably configured game, and for updating the firmware and OS of the Playstation 3 device itself. It will be appreciated that the term “on-line” does not imply the physical presence of wires, as the term can also apply to wireless connections of various types.

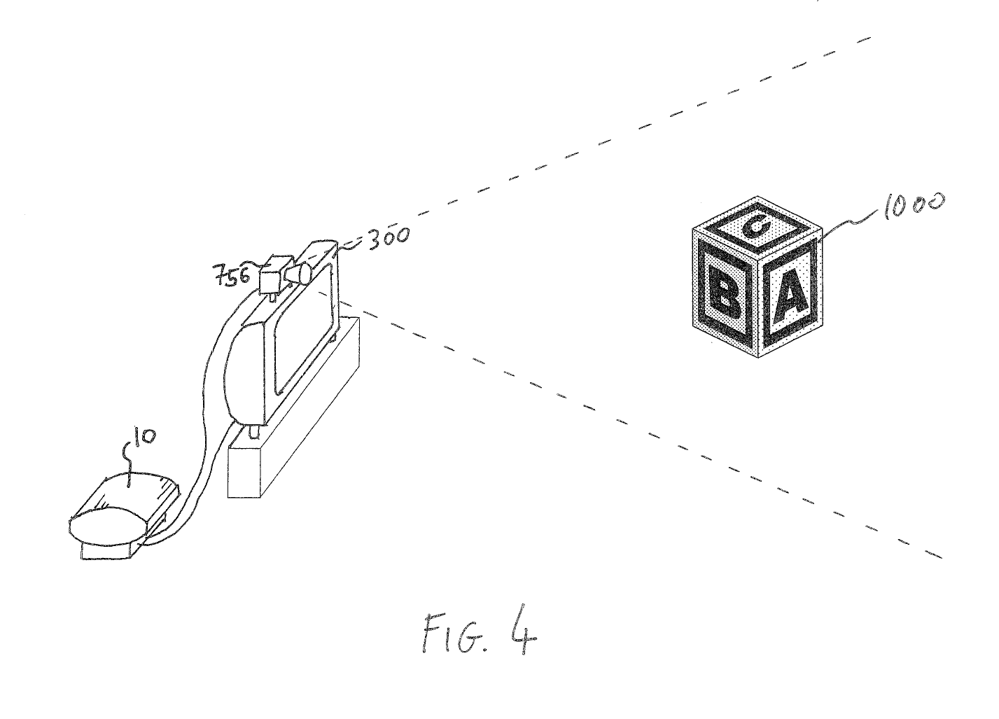

Embodiments of the present invention in which an augmented reality marker is supplied to an end-user will now be described with reference to FIGS. 4 to 9.

FIG. 4 shows a schematic diagram of an entertainment system arranged to detect an augmented reality marker so that a user may interact with a video game. In the embodiments described below, the entertainment system is the same as that described above with reference to FIGS. 1 to 3. However, it will be appreciated that any suitable entertainment system could be used.

In particular, FIG. 4 shows the entertainment device 10, which is operably connected to the video camera 756 and the display and sound output device 300. Other elements of the entertainment system such as the game controller 751 have been omitted from FIG. 4 for the sake of clarity in understanding the drawing. In embodiments of the present invention, the video camera 756 is arranged to capture images of augmented reality marker 1000 as shown by the dash lines in FIG. 4. The cell processor 100 then generates virtual images based on the detection of the augmented reality marker 1000. The virtual images are then combined with the captured video images so that a user may interact with the virtual images using the augmented reality marker 1000.

In embodiments of the present invention, the augmented reality marker 1000 allows a user to interact with, for example a virtual pet, which may be displayed in combination with images of the real environment. For example, the virtual pet may be displayed such that it appears to walk or run around within the real environment. This provides a user with images which make it appear as if the virtual pet is actually within, for example, the user's living room.

In order to provide greater interaction between the virtual pet and the user, the cell processor 100 is operable to detect, by analysing the sequence of video images captured by the video camera 756, the augmented reality marker 1000. The cell processor 100 can then generate appropriate instructions to cause the graphics processor RSX 200 to render virtual images which correspond to virtual objects associated with the augmented reality marker 1000. For example, the augmented reality marker 1000 could be associated with a perch for the virtual pet or a feeding bottle for the virtual pet. However, it will appreciated that any other suitable virtual object could be associated with the augmented reality marker 1000.

For example, where the augmented reality marker 1000 is associated with a perch for the virtual pet, the cell processor 100 can track the location of the marker 1000 within the captured video images using known techniques and cause an image of the perch to be displayed combined or superimposed with the real images at an image position substantially corresponding to that of the augmented reality marker 1000. The cell processor 100 can then, for example, cause the pet to move towards the augmented reality marker 1000 and sit on the virtual perch.

A way in which the augmented reality marker 1000 is detected in accordance with embodiments of the present invention will now be described.

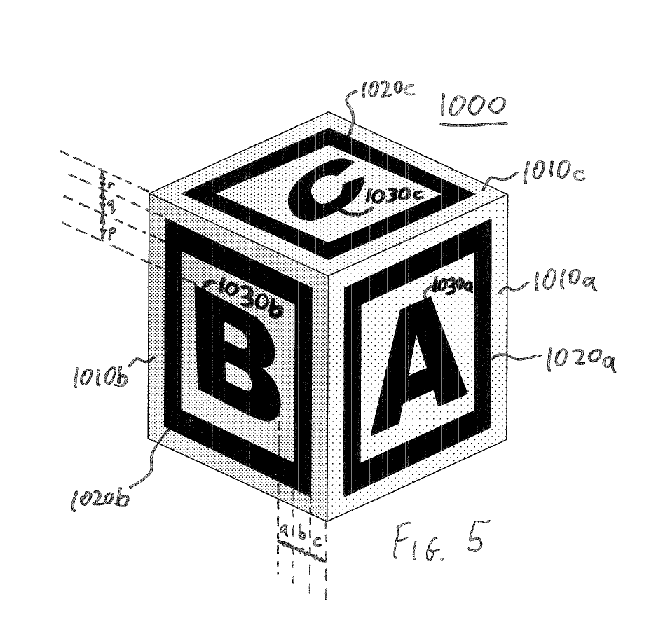

FIG. 5 shows an augmented reality marker 1000 which may be used to interact with a virtual pet in accordance with embodiments of the present invention. In the embodiments shown in FIG. 5, the augmented reality marker 1000 is three dimensional and comprises a plurality of facets 1010a, 1010b, and 1010c, each of which comprises a respective image of a square 1020a, 1020b, and 1020c, together with respective alpha numeric characters such as the letter “A” 1030a, “B” 1030b, and “C” 1030c.

In the embodiment shown in FIG. 5, the augmented reality marker 1000 is three dimensional, although it will be appreciated that a two dimensional augmented reality marker could also be used. Furthermore, it will be appreciated that other shapes of three dimensional and two dimensional augmented reality markers may be used, and that other images suitable for detection by the cell processor 100 may act as images on the augmented reality marker.

To detect the augmented reality marker 1000, the cell processor 100 analyses the images captured by the video camera 756. The cell processor 100 applies an image threshold to the captured images so as to generate a binary black and white image. The cell processor 100 then detects pixel regions which are likely to correspond to the squares 1020a, 1020b and 1020c (also referred to as “quads”), using known techniques such as edge following and template matching.

However, in most arrangements of the augmented reality marker 1000 with respect to the video camera 756, the optical axis of the video camera 756 will not be perpendicular to at least some of the facets 1010a, 1010b, and 1010c. Therefore, the captured images of the facets 1010a, 1010b, and 1010c, are likely to be distorted. To address this, when detection of quads is carried out by the cell processor 100, the cell processor 100 is operable to detect rotational, skew, and trapezoidal transforms and the like of the augmented reality marker 1000 using known techniques.

Those regions of an analysed image which are detected by the cell processor 100 as comprising quads are then analysed using known techniques to detect whether there is an alphanumeric character (e.g. the letter A) 1030a within the square 1020a. Similar processing may be carried out on the other two facets 1010b, and 1010c. The cell processor 100 then calculates a probability associated with each image region which is detected as comprising an alphanumeric character together with a quad. However, it will be appreciated that the symbol within a quad need not be an alphanumeric character and could be a barcode or other identifying symbol.

In the embodiment shown in FIG. 5, the three facets of the augmented reality marker 1000 are arranged adjacently so as to form a corner of a cuboid. Therefore, in one embodiment, the cell processor is operable to detect whether the image regions which comprise alphanumeric characters within a quad are congruent with each other. If any quads are detected which are not congruent with each other, then the corresponding image regions are unlikely to comprise the marker 1000 and are thus designated by the cell processor 100 as not comprising the marker 1000.

The cell processor then detects which image region has the highest probability of comprising the marker 1000 and labels that region as corresponding to the augmented reality marker 1000. The cell processor 100 then generates virtual reality images which may be combined with the real images captured by the video camera 756 for display on the sound and output device 300 as described above.

In the example augmented reality marker shown in FIG. 5, a distance (denoted “a” in FIG. 5) between the alphanumeric character B 1030b and the inside of the quad 1020b is substantially the same as that of a thickness (denoted “b” in FIG. 5) of the quad 1020b and a distance (denoted “c” in FIG. 5) between the outside of the quad 1020b and an outside edge of the facet 1010b. Additionally, a distance (denoted “p” in FIG. 5) between the alphanumeric character B 1030b and the inside of the quad 1020b is substantially the same as that of a thickness (denoted “q” in FIG. 5) of the quad 1020b and a distance (denoted “r” in FIG. 5) between the outside of the quad 1020b and an outside edge of the facet 1010b. In other words, in an embodiment, a=b=c=p=q=r. The patterns and symbols on the other facets 1010a and 1010c have similar respective distances to those on the facet 1010b. This assists the cell processor 100 in detecting the marker because the marker 1000 can be split up into a grid of 5 by 5 sub regions which may be individually analysed by the cell processor 100 so as to help detect a quad together with an alphanumeric character, other symbol or pattern.

In an embodiment, the cell processor 100 is operable to detect the augmented reality marker 1000 in dependence upon augmented reality marker data which is associated with the augmented reality marker 1000. In an embodiment, the augmented reality marker data relates to undistorted versions of the facets of the augmented reality marker 1000. Therefore, once the augmented reality marker 1000 has been detected, the distortion of each of the facets 1010a, 1010b, and 1010c, may then be advantageously analysed using known techniques to detect a relative orientation of the marker 1000 with respect to the video camera 756.

To achieve this, the cell processor 100 compares each respective undistorted version of each facet with the corresponding facet and calculates the rotational, skew and trapezoidal transforms necessary to map the detected image regions to the undistorted versions of the respective facets. The cell processor 100 then uses the mapping between the undistorted version of each facet and the respective distorted version detected within the captured video images to calculate the relative aspect of the marker 1000 with respect to the video camera 756. It will be appreciated that other suitable techniques for detecting the distortion of the marker and generating a map between the undistorted version and the captured distorted image could be used.

By detecting the relative aspect or pose of the marker 1000 with respect to the video camera 756, the cell processor can cause the RSX 200 to render virtual images so that they correspond to, for example, the tilt of the marker 1000 with respect to the camera 756.

However, it will be appreciated that other suitable methods for detecting the relative orientation and position of the augmented reality marker 1000 with respect to the video camera 756 may be used.

In an embodiment, the augmented reality marker data relates to the shape and size of the marker 1000. The augmented reality marker data is preloaded into the XD RAM 500 from a suitable recording medium such as a Blu-ray® disc 40 or from the hard disc drive HDD 400. Additionally or alternatively, augmented reality marker data may be received via a network such as the internet using the Ethernet port 720, possibly in cooperation with a suitable modem.

Once the augmented reality marker 1000 has been detected, the cell processor 100 is operable to generate a virtual reality image in dependence upon the augmented reality marker data. The cell processor 100 then generates instructions which cause the graphics processor RSX 200 to combine the generated virtual reality image with the sequence of video images so that the virtual reality image is combined at a position substantially corresponding to that of the augmented reality marker 1000.

In embodiments of the invention, the augmented reality data relates to the type of object with which the augmented reality marker 1000 is associated. For example, the augmented reality marker data could comprise instructions which the cell processor 100 can execute so as to generate a virtual object such as a perch for the virtual pet. By using a three dimensional augmented reality marker 1000 such as a cube as shown in FIG. 5, the position and orientation of the marker 1000 with respect to the video camera 756 may be advantageously detected. This then allows the cell processor 100 to generate the virtual object (such as a perch) and cause the orientation of the virtual object to change in accordance with a change in orientation of the virtual reality marker 1000.

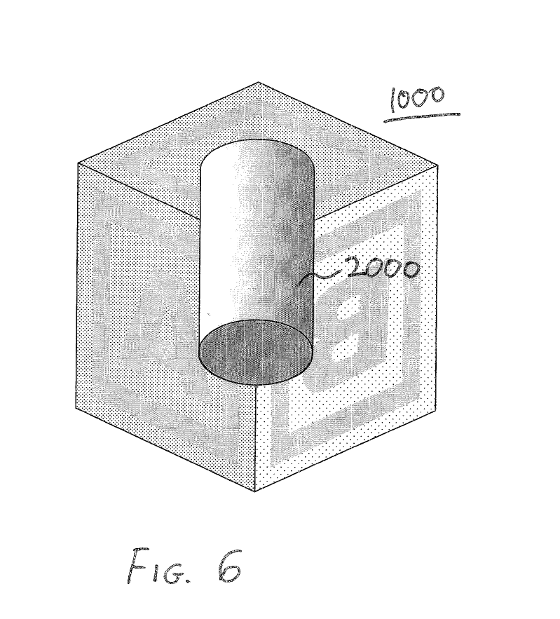

To facilitate manipulation of the augmented reality marker 1000 by the user and improve the ease of use for the user, in an embodiment the augmented reality marker 1000 comprises a handle by which the marker 1000 may be held. An example of this is shown in FIG. 6.

FIG. 6 shows a schematic diagram of a rear view of the augmented reality marker 1000. As can be seen from FIG. 6, the three facets 1010a, 1010b, and 1010c of the augmented reality marker 1000 are arranged adjacently so as to form a corner of a cuboid. In the embodiment shown in FIG. 6, the augmented reality marker 1000 comprises a handle 2000 by which the marker 1000 may be held by the user. Accordingly, the user may hold the handle 2000 such that their hand is behind the marker and not visible from the point of view of the video camera 756. This advantageously allows a user to hold the marker 1000 without obscuring any of the image features on the facets necessary for the cell processor 100 to detect the augmented reality marker 1000, thus improving the likelihood that the marker 1000 and the pose and aspect of the marker 1000 with respect to the camera 756 will be detected correctly.

In the embodiment shown in FIG. 6, the handle 2000 is attached to the underside of the facet 1010c, although it will be appreciated that the handle 2000 may attach to the marker 1000 in any suitable way so as to allow the user to hold the marker such that the users hand is unlikely to be visible from a point of view of the video camera 756. In some embodiments, the handle 2000 is removably attached to the marker 1000, for example using a suitable fabric hook and loop fastening, although it will be appreciated that other suitable methods of fastening the handle 2000 to the marker 1000 may be used.

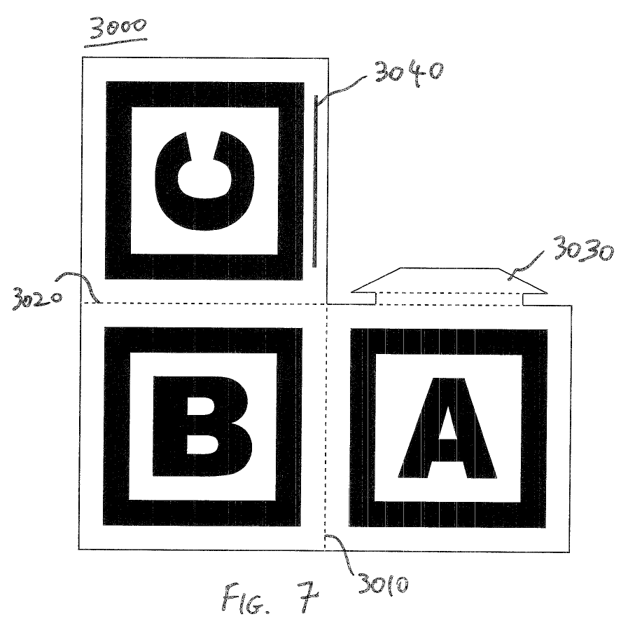

An embodiment of the present invention in which the augmented reality marker 1000 may be supplied to the user in a form such that the user can assemble the marker 1000 to form the marker in the embodiments shown in FIGS. 4 and 5 will now be described with reference to FIG. 7.

FIG. 7 shows a schematic diagram of a polyhedral augmented reality net representation 3000 (referred to as a net 3000 throughout) of the marker which may be used to assemble the augmented reality marker 1000. In an embodiment, the net 3000 may be printed on a suitable surface such that a user may, for example, cut out the net 3000 from a material on which the net is printed and assemble the net 3000 so as to form the marker 1000.

In FIG. 7, image features corresponding to the facets 1010a, 1010b, 1010c are shown arranged so as to form the net 3000. The net 3000 may be folded along a dashed line 3010 and a dashed line 3020 so that the facets form respective faces of a cuboid and the facets are arranged to be substantially adjacent to each other. A user can thus assemble the marker 1000 in a straightforward manner.

In the embodiment shown in FIG. 7, the net 3000 also comprises a tab 3030 which may be inserted into a corresponding slot 3040 so as to hold the facets so that they are adjacent to each other and form a corner of a cuboid. Therefore, the marker 1000 may be supplied to the end-user of the marker 1000 in a substantially flat form (i.e. the net 3000) in which the facets of the net are arranged to be substantially coplanar with each other. The end-user may then assemble the marker 1000 so that the facets are no longer arranged to be coplanar with each other. In this way, the marker 1000 can be advantageously supplied to the end-user as a free promotional supplement to a product. However, it will be appreciated that other suitable methods of constructing a net which may form the augmented reality marker 1000 may be used. For the avoidance of doubt the net 3000 should be taken to be synonymous with the augmented reality marker 1000 because the net 3000 can be used to form the marker 1000 which is detected by the entertainment system 10.

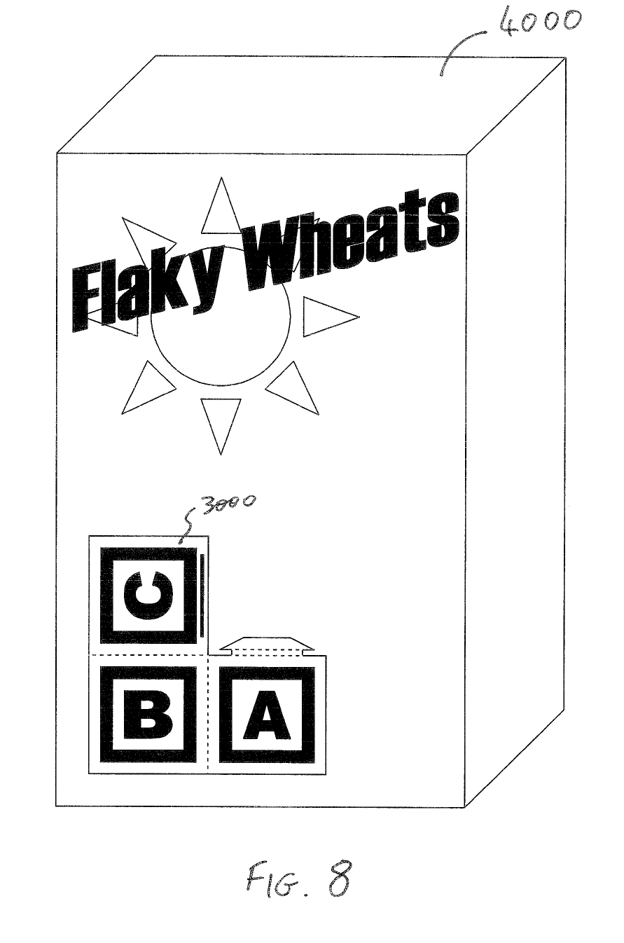

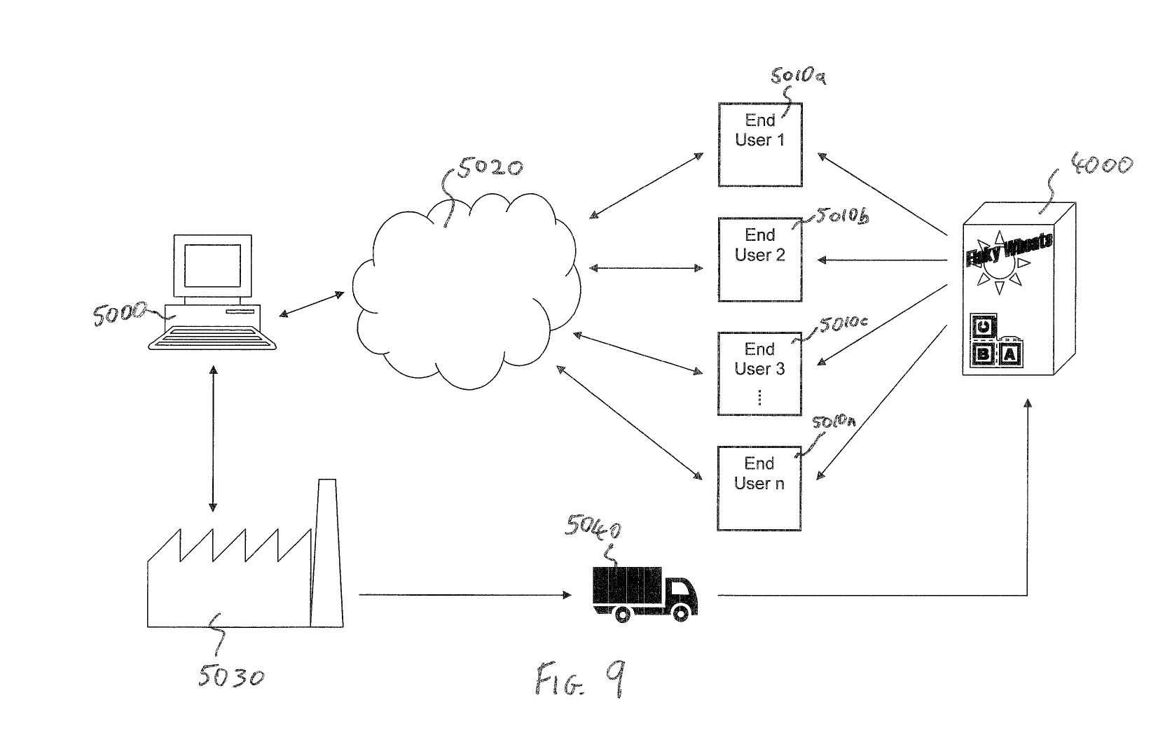

An embodiment of the present invention in which the augmented reality marker is supplied in association with a product to an end-user will now be described with reference to FIGS. 8 and 9.

FIG. 8 is a schematic diagram of a product to be supplied to an end-user of the product as a method of rewarding the end-user. In the embodiment shown in FIG. 8, the product is a cereal packet 4000 on which the augmented reality marker net 3000 is printed. Accordingly, the augmented reality marker can be provided as a free promotional supplement to the product, for example to promote the release of an augmented reality game or an added functionality relating to that game. Furthermore, the augmented reality marker could be associated with, for example, the release of a film, or the broadcast of a TV programme. For the avoidance of doubt, here “free” is taken to mean the same as “at no cost to the end-user”. Additionally, it will be appreciated that the supply of the marker in association with a product may incur a cost to a supplier of the product. However, the supply of an augmented reality marker in association with a product to an end-user will not add any extra cost to the product for the end-user above that of the product itself.

However, it will be appreciated that the product 4000 could be any product suitable for supply to an end user, and that the marker could be associated with any suitable promotional aspect or advertising. Accordingly, the augmented reality marker net 3000 may act as an augmented reality marker for use with an augmented reality application such as a virtual pet game once the net 3000 is distributed to an end user. However, it will be appreciated that the augmented reality application could be any suitable application such as a home planning application which could allow a user to lay out objects within their room so as to visualise furniture which they might buy.

Although in the embodiment shown in FIG. 8 the marker is shown printed on the product 4000, in other embodiments, the augmented reality marker can be provided within a product package, printed on the product package, or printed on the product itself. Furthermore, the augmented reality marker 1000 need not be three dimensional and could be two-dimensional in the form of a card, board, and the like. Additionally, the augmented reality marker could be in a form so as to allow an image corresponding to the marker to be transferred to another surface.

A method and system of supplying the augmented reality marker in association with the product 4000 will now be described with reference to FIG. 9.

FIG. 9 shows a server 5000 which is operable to communicate bi-directionally via a communications network 5020 such as the internet with a plurality of client devices, each associated with a respective end-user (e.g. end-user 1 5010a, end-user 2 5010b, end-user 3 5010c, and up to end-user n 5010n). The server 5000 is also operable to communicate bi-directionally with a supply source 5030 for distributing the product 4000 together with an augmented reality marker to the plurality of end users via a distribution channel 5040. Typically, the distribution channel comprises sending the product from a product storage location such as a warehouse to a retail outlet by a suitable form of transport such as a lorry although it will be appreciated that other forms of distribution channel could be used.

In the embodiment shown in FIG. 9, each client device associated with each end user is the entertainment device 10 described above with reference to FIG. 1 to 3, although it will be appreciated that any other suitable entertainment device or personal computer could be associated with an end user.

In an embodiment, the augmented reality marker is supplied in association with the product 4000 to the end users 5010a, 5010b, 5010c up to 5010n, where n represents any number of end users. Accordingly, the augmented reality marker may be provided as a free promotional supplement to the product 4000.

In an embodiment, when the product is distributed to an end-user, the augmented reality marker data is also be made available to the end-user so that their client device may detect the augmented reality marker. In one embodiment, the augmented reality marker data is provided from the server 5000 via the communications network 5020 to the client device associated with the end-user. In a further embodiment, the augmented reality marker data is transmitted to the client device via the communications network 5020 in response to a request from the client device associated with that end-user that the augmented reality marker data should be sent from the server 5000 to the client device. In other words, the server 5000 may act as a data source.

The client device may generate the request for the augmented reality data in response to a user input that they have received an augmented reality marker or in response to a detection by the cell processor of, for example, a quad which indicates the presence of a marker. However, it will be appreciated that other suitable techniques could be used to initiate the transmission of the augmented reality marker data from the server to the client or reading of the augmented reality marker data from a suitable storage medium.

In another embodiment, the augmented reality marker data is transmitted to the client device via the communications network 5020 in response to an indication by the supply source 5030 to the server 5000 that the augmented reality marker is to be supplied to one or more of the end users. For example, this may occur when a new product is about to be released or where a product already exists but a new marker associated with an existing augmented reality video game is about to be released. This enables the augmented reality marker to be detected by a client device associated with an end user in dependence upon the augmented reality marker data.

Additionally, in an embodiment, the augmented reality marker data comprises data relating to the shape and size of the augmented reality marker 1000. Accordingly, the client device may analyse video images captured by the video camera 756 so as to detect the augmented reality marker 1000 as described above with reference to FIGS. 4 to 6.

In other embodiments, the augmented reality marker data may be provided on a removable storage medium such as a CD-ROM, DVD-ROM, Blu-ray® disc, flash memory card, and the like. In some embodiments, the removable storage medium can be the product itself and the augmented reality marker may be printed on the removable storage medium.

In some embodiments, the augmented reality marker data comprises data associated with functionality of a game. For example, where the game is a virtual pet game, the augmented reality data can comprise data relating to an optional appearance of the pet (for example, long, stripy fur) together with data relating to a song to which the pet may sing along. However, it will be appreciated that the augmented reality data may comprise other data relating to the functionality of an augmented reality application with which the augmented reality marker may be used.

In use, the entertainment device (client device) is operable to read the augmented reality marker data from the removable storage medium so as to allow the client device to detect the augmented reality marker 1000 and generate the virtual reality images accordingly as described above.

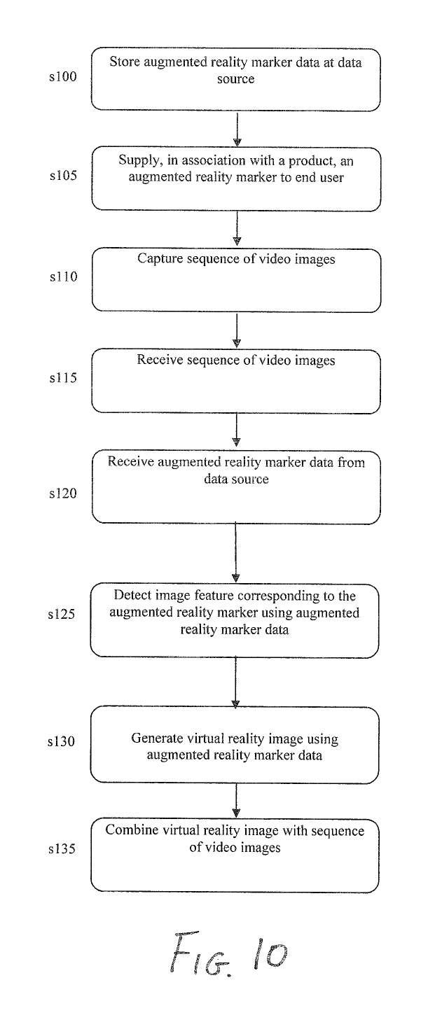

A method of combining virtual images with real images so as to generate augmented reality images in accordance with embodiments of the present invention will now be described with reference to FIG. 10.

At a step s100, the augmented reality marker data is stored at a data source. As described above, the data source may be the server 5000, a removable storage medium or any other suitable data source. In some embodiments, the product comprises the removable storage medium and the augmented reality marker data is stored by the server 5000 to the removable storage medium for supply to an end-user.

At a step s105, the augmented reality marker 1000 is supplied in association with the product to the end-user. The augmented reality marker is provided as a free promotional supplement to the product and the augmented reality marker is associated with the augmented reality marker data stored at the data source. This allows the augmented reality marker 1000 to be detected by a client device associated with the end-user as described above.

At a step s110, the video camera 756 captures a sequence of video images of the real environment comprising the augmented reality marker and transmits the images to the entertainment device 10. Then, at a step s115, the entertainment device 10 (i.e. a client device associated with an end-user) receives the sequence of video images via a suitable communications port such as the USB port 710. Additionally, at a step s120, the entertainment device receives the augmented reality marker data form the data source.

In the embodiment described above where the augmented reality marker data is sent from the server 5000 to the client device, the augmented reality marker is received via the communications network 5020 at the ethernet port 720 and sent to the cell processor 100 via the I/O bridge 700. However, where the augmented reality marker data is stored on a storage medium such a the hard drive 400 or on a removable storage medium such as a DVD-ROM 440, the cell processor 100 receives the data form the appropriate medium via the I/O bridge 700.

Then, at a step s125, the cell processor 100 detects an image feature which corresponds to the augmented reality marker within the sequence of video images captured by the video camera and received by the entertainment device at the step s115. The detection of the image feature corresponding to the augmented reality marker is carried out by the cell processor by analysis of the video images in dependence upon the augmented reality marker data as described above.

At a step s130, the cell processor 1000 generates a virtual reality image in dependence upon the augmented reality marker data received from the data source at the step s120. The cell processor 100 then combines, at a step s135, the virtual reality image generated at the step s130 with the video images received at the step s115 so that the RSX200 can cause the display 305 to render the virtual reality image at a position substantially corresponding to the detected image feature. Therefore, augmented reality images may be generated by the cell processor 100 so as to give the user an illusion that, for example, a virtual pet is in their living room. Furthermore, the end-user can use the augmented reality marker to interact with the virtual pet.

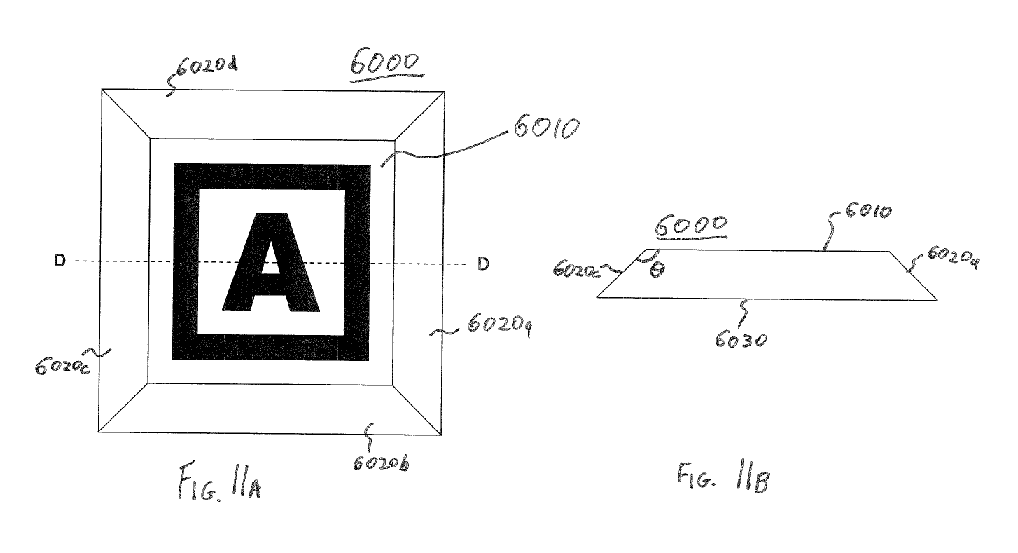

An augmented reality marker which may be used as an augmented reality marker as described above will now be described with reference to FIGS. 11A and 11B.

FIG. 11A shows an augmented reality marker in accordance with an embodiment of the present invention. In particular, FIG. 11A shows an augmented reality marker 6000 having a primary facet 6010. In an embodiment, the primary facet comprises an image for recognition by the system unit 10 together with the video camera 756 as described above. For example, the primary facet 6010 can comprise a quad together with an alphanumeric character as described above with reference to FIG. 5. However, it will be appreciated that the primary facet 6010 could comprise any other suitable symbol or pattern.

The augmented reality marker 6000 shown in FIGS. 11A and 11B also comprises a plurality of secondary facets 6020a, 6020b, 6020c, and 6020d. The secondary facets 6020a, 6020b, 6020c, and 6020d are arranged with respect to the primary facet 6010 such that said primary facet 6010 together with said secondary facets 6020a, 6020b, 6020c, and 6020d form faces of a truncated pyramid. In the embodiment shown in FIGS. 11A and 11B, the primary facet surmounts the truncated pyramid as shown in FIG. 11B.

FIG. 11B is a cross-sectional view of the augmented reality marker shown in FIG. 11A taken along a line as illustrated by the dashed line D-D in FIG. 11A. As can be seen from FIG. 11B, the primary facet 6010 surmounts the truncated pyramid (i.e. is at the top of the marker) and the secondary facets 6020a and 6020c form two faces of the truncated pyramid.

In some embodiments, the augmented reality marker 6000 also comprises a base which forms a bottom face of the truncated pyramid as illustrated in FIG. 11B. In this case, the truncated pyramid forms a closed volume. However, other embodiments of the marker shown in FIG. 11A do not have a base meaning that the truncated pyramid is open at the bottom.

In use, the marker 6000 is typically held by the user such that the primary facet 6010 faces towards the video camera 756. In some embodiments, a handle may also be attached to a side of the marker 6000 positioned opposite from the primary facet 6010 (i.e. on the reverse side of the primary facet 6010 or on the base 6030). This facilitates manipulation of the marker 6000 by the user.

By arranging one or more secondary facets so that they are not parallel with the primary facet 6010, the system unit 10 can cooperate with the video camera 756 so as to detect a tilt and pose of the augmented reality marker 6000 with respect to the camera 756 in a similar manner to that described above for the augmented reality marker 1000.

For example, if the secondary facet 6020b is slightly further away from the video camera that the secondary facet 6020d (i.e. the top of the marker 6000 is tilted towards the video camera 756), it may be difficult for the system unit 10 to determine whether the top of the marker 6000 is tilted towards or away from the camera if the symbol within the quad cannot be resolved sufficiently or the image on the primary facet 6010 has some degree of symmetry. Therefore, the cell processor 100 can compare the relative image sizes of image features corresponding to the secondary facets 6020b and 6020d so as to help resolve any ambiguity in tilt direction. The cell processor 100 can carry out similar image processing with respect to the secondary facets 6020a and 6020c. In other words, the cell processor 100 is operable to detect the relative distortions of the secondary facets 6020a, 6020b, 6020c, and 6020d so as to detect a relative orientation and tilt of the marker 6000 with respect to the video camera 756.

In some embodiments, the secondary facets 6020a, 6020b, 6020c, and 6020d are a different colour from the primary facet 6010. This helps distinguish the primary facet 6010 from the secondary facets 6020a, 6020b, 6020c, and 6020d. Additionally, in some embodiments, one or more of the secondary facets 6020a, 6020b, 6020c, and 6020d may have a different colour from each other. The cell processor 100 is operable to carry out colour detection on image features corresponding to the secondary facets 6020a, 6020b, 6020c, and 6020d. This further helps resolve any ambiguity as to the relative orientation of tilt of the marker 6000 with respect to the video camera 756.

It will be appreciated that in some embodiments, the marker 6000 may comprise the primary facet together with one or more secondary facets arranged so that the primary facet is nor parallel to the one or more secondary facets. For example, the marker could comprise the primary facet 6010 together with the secondary facet 6020c such that an angle between the primary facet 6010 and the secondary facet 6020c (denoted θ in FIG. 11B) is not equal to 90 degrees. In other words the primary facet is not parallel (θ=180 degrees) to the secondary facet.

Preferably, where there are one or more facets each having a respective angle θ with respect to the primary facet, the angle θ lies in the range 180>θ≧90. However, it will be appreciated that the angle θ could be 90 degrees or less although this reduces the likelihood that the secondary facets can be used to resolve any tilt ambiguities. Additionally, it will be appreciated that each secondary facet could form a different respective angle with the primary facet and that the edges of the facets need not be contiguous with each other. Furthermore, the marker could be frustroconical, or the primary and secondary facets could be arranged to form any other suitable pyramidal frustrum.

It will be appreciated that the marker 6000 may be formed from suitable net in a similar way to that described above with reference to FIG. 7. Furthermore, the marker 6000 may be supplied to end-users as a free promotional supplement to a product in a similar manner to that described above with reference to FIGS. 8 and 9.

Further background information relating to the description of the embodiments given above can be found in European Application Number . . . (Agents Ref: P034863EP) and European Application Number . . . (Agents Ref: P034095EP), the entire contents of which are hereby incorporated herein by reference.

The various methods set out above may be implemented by adaptation of an existing entertainment device, for example by using a computer program product comprising processor implementable instructions stored on a data carrier such as a floppy disk, optical disk, hard disk, PROM, RAM, flash memory or any combination of these or other storage media, or transmitted via data signals on a network such as an Ethernet, a wireless network, the Internet, or any combination of these of other networks, or realised in hardware as an ASIC (application specific integrated circuit) or an FPGA (field programmable gate array) or other configurable circuit suitable to use in adapting the existing equivalent device.

In conclusion, although illustrative embodiments of the invention have been described in detail herein with respect to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A method of rewarding an end-user of a product, wherein said method comprises supplying, in association with said product, an augmented reality marker for use with an augmented reality application, and said augmented reality marker is provided as a free promotional supplement to said product.

2. The method of claim 1, wherein said product and said augmented reality marker are supplied to said end-user following purchase of said product by said end-user.

3. The method of claim 1, wherein said product is supplied within a product package and said augmented reality marker is printed on said product package.

4. The method of claim 1, wherein said product is supplied within a product package and said augmented reality marker is supplied within said product package.

5. The method of claim 1, wherein said augmented reality marker is printed on said product.

6. The method of claim 1, wherein said product is supplied within a product package and said augmented reality marker is removably attached to said product package.

7. The method of claim 1, wherein said augmented reality application is associated with a client device associated with said end-user, said client device having an image receiver and a data receiver, and said product and augmented reality marker being supplied from a supply source, said method comprising:
storing, at a data source, augmented reality marker data associated with said augmented reality marker;
capturing, using a video camera, a sequence of video images of said augmented reality marker;
receiving, using said image receiver, said sequence of video images via an image communication link;
receiving, using said data receiver, said augmented reality marker data from said data source;
detecting, at said client device, an image feature corresponding to said augmented reality marker within said sequence of video images, said augmented reality marker being detected in dependence upon said augmented reality marker data received from said data source; and
generating, at said client device, a virtual reality image in dependence upon said augmented reality marker data received from said data source; and
combining, at said client device, said virtual reality image with said sequence of video images at an image position substantially corresponding to said image feature so as to generate augmented reality images.

8. The method of claim 7, wherein said augmented reality marker is a three dimensional augmented reality marker.

9. The method of claim 8, wherein:
said augmented reality marker comprises at least two facets having respective distinct image features;
said augmented reality marker data relates to un-distorted versions of said respective distinctive image features; and
said method comprises:
detecting, by analysis of said sequence of video images, a three dimensional orientation of said augmented reality marker with respect to said video camera in dependence upon a relative distortion of image features within said sequence of video images corresponding to said respective facets of said augmented reality marker with respect to said un-distorted versions of said respective distinct image features.

10. The method of claim 8, wherein said three dimensional augmented reality marker comprises three facets arranged adjacently so as to form a corner of a cuboid.

11. The method of claim 10, wherein said three dimensional augmented reality marker comprises a handle by which the marker may be held by said end-user.

12. The method of claim 8, wherein:
said augmented reality marker comprises at least two marker elements having respective distinct image features;
said marker elements can be arranged in a first position for supply to said end-user, said first position being such that said marker elements are arranged to be substantially co-planar with each other; and
said marker elements can be arranged in a second position for detection, said second position being such that said marker elements are arranged not to be substantially co-planar with each other.

13. The method of claim 7, wherein said product comprises said data source, and said data source is a storage medium.

14. The method of claim 13, wherein said augmented reality marker is printed on said storage medium.

15. The method of claim 7, wherein:
said data source comprises a server; and
said method comprises transmitting said augmented reality marker data to said data receiver via a communications network.

16. The method of claim 15, comprising transmitting said augmented reality marker data to said data receiver via said communications network in response to a request from the client device that said augmented reality marker data should be sent from said data source to said client device.

17. The method of claim 15, comprising transmitting said augmented reality marker data to said data receiver via said communications network in response to an indication by said supply source that said augmented reality marker is to be supplied to said end-user.

18. The method of claim 7, wherein said augmented reality marker data comprises game data which relates to a game characteristic associated with said virtual reality image.

19. The method of claim 7, wherein:
said augmented reality marker data comprises rendering data; and
said method comprises generating said virtual reality image for display in dependence upon said rendering data.

20. An image combining method for combining virtual images with real images captured by a video camera so as to generate augmented reality images at a client device associated with an end-user, said client device having an image receiver and a data receiver, said method comprising:
storing, at a data source, augmented reality marker data;
supplying, in association with a product, an augmented reality marker to said user, said augmented reality marker being provided as a free promotional supplement to said product, and said augmented reality marker being associated with said augmented reality marker data;
capturing a sequence of video images of said augmented reality marker;
receiving, using said image receiver, said sequence of video images via an image communication link;
receiving, using said data receiver, said augmented reality marker data from said data source;
detecting, at said client device, an image feature corresponding to said augmented reality marker within said sequence of video images, said augmented reality marker being detected in dependence upon said augmented reality marker data received from said data source; and
generating, at said client device, a virtual reality image in dependence upon said augmented reality marker data received from said data source; and
combining, at said client device, said virtual reality image with said sequence of video images at an image position substantially corresponding to said image feature so as to generate augmented reality images.

21. An image combining system arranged to combine virtual images with real images captured by a video camera so as to generate augmented reality images, said system comprising:
a data source arranged to store augmented reality marker data;
a supply source arranged to supply, in association with a product, an augmented reality marker to an end-user, said augmented reality marker being provided as a free promotional supplement to said product, and said augmented reality marker being associated with said augmented reality marker data;
a video camera operable to capture video images of the augmented reality marker; and
a client device associated with said end-user, said client device comprising:
an image receiver operable to receive a sequence of video images from said video camera via an image communication link;
a data receiver operable to receive said augmented reality marker data from said data source;
a detector operable to detect, within said sequence of video images, an image feature corresponding to said augmented reality marker which was supplied from said supply source, said image feature being detected in dependence upon said augmented reality marker data received from said data source; and
a processor operable to: generate a virtual reality image in dependence upon said augmented reality marker data received from said data source; and combine said virtual reality image with said sequence of video images at an image position substantially corresponding to said image feature so as to generate augmented reality images.

22. An image combining device for combining virtual images with real images captured by a video camera so as to generate augmented reality images, said device being associated with an end-user, and said device comprising:
an image receiver operable to receive a sequence of video images from said video camera via an image communication link;
a data receiver operable to receive augmented reality marker data from a data source, said augmented reality marker data being associated with an augmented reality marker;
a detector operable to detect, within said sequence of video images, an image feature corresponding to said augmented reality marker, said augmented reality marker being supplied to said end-user in association with a product, said augmented reality marker being provided as a free promotional supplement to said product, and said image feature being detected in dependence upon said augmented reality marker data received from said data source; and
a processor operable to: generate a virtual reality image in dependence upon said augmented reality marker data received from said data source; and combine said virtual reality image with said sequence of video images at an image position substantially corresponding to said image feature so as to generate augmented reality images.

23. An augmented reality marker for use with an augmented reality generation system, said augmented reality marker comprising:
a primary facet comprising an image for recognition by said augmented reality generation system; and
one or more secondary facets arranged with respect to said primary facet such that said primary facet is not parallel to said one or more secondary facets.

24. The augmented reality marker of claim 23, wherein said one or more secondary facets together with said primary facet form faces of a truncated pyramid, and said primary facet surmounts said truncated pyramid.

25. The augmented reality marker of claim 23, wherein said one or more secondary facets are a different colour from said primary facet.
